(19) United States
(12) Patent Application Publication
(10) Pub. No.: US 2026/0164179 A1
(43) Pub. Date: Jun. 11, 2026

(54) Headphone Headband with Integral Hinge

(71) Applicant: Bose Corporation, Framingham, MA (US)

(72) Inventors: Zhen Xu, Milford, MA (US); Allen Timothy Graff, Sutton, MA (US)

(21) Appl. No.: 18/973,367

(22) Filed: Dec. 9, 2024

(51) Int. Cl. H04R 5/033

(52) U.S. Cl. CPC H04R 5/0335

(57) ABSTRACT

Aspects include headphones and headbands for headphones. In certain cases, a headphone headband includes: a cushion assembly; a slider telescopically coupled to the cushion assembly, the slider comprising a proximal end disposed within the cushion assembly and a distal end extending outward from the cushion assembly; an earphone; and a yoke coupling the earphone to the distal end of the slider, wherein the slider includes an internal hinge enabling the yoke to pivot relative to a primary axis of the slider.

### BACKGROUND

The disclosure relates generally to wearable audio devices. More particularly, the disclosure relates to headphones and related headbands.

### SUMMARY

Various implementations are directed to headphones and related headbands for headphones. In certain cases, a headphone headband includes an integral hinge.

In particular cases, a headphone headband includes: a cushion assembly; a slider telescopically coupled to the cushion assembly, the slider comprising a proximal end disposed within the cushion assembly and a distal end extending outward from the cushion assembly; an earphone; and a yoke coupling the earphone to the distal end of the slider, where the slider includes an internal hinge enabling the yoke to pivot relative to a primary axis of the slider.

All examples and features mentioned below can be combined in any technically possible way.

In certain cases, the internal hinge is contained within walls of the slider.

In some cases, the slider includes an inner wall and an outer wall that collectively form an arcuate slot. In some examples, two arcuate slots are present, one on each side of the pivot member, for receiving two arcuate protrusions.

In certain cases, the headphone headband further includes a pivot member extending from a neck portion of the yoke into the arcuate slot, the pivot member having a set of arcuate protrusions complementing the arcuate slot.

In some aspects, the pivot member further includes a set of stops that limit movement of the pivot member relative to the arcuate slot.

In certain implementations, the slider includes an inner wall section and an outer wall section that collectively define a hinge slot.

In particular cases, the inner wall section includes a first set of force-fit couplers and the outer wall section includes a second set of complementary force-fit couplers. In some examples, the force-fit couplers include mating slots and complementary protrusions, snap-fit couplers, slide-to-fit couplers, etc.

In certain aspects, the first set of force-fit couplers and the second set of force-fit couplers enables fastener-free connection between the inner wall section and the outer wall section.

In some cases, the first set of force-fit couplers includes a set of slots and the second set of force-fit couplers includes a set of protrusions, where each of the slots includes a loading portion and a locking portion. In some examples, slots are oversized relative to protrusions in at least one dimension, enabling loading, unloading, and locking.

In particular implementations, at least one of the inner wall section or the outer wall section includes a set of stabilizing protrusions that inhibit deflection of the inner wall section relative to the outer wall section.

In some aspects, the internal hinge includes a bracket coupled with the yoke and housed within walls of the slider.

In certain cases, the bracket includes an arcuate slot and the slider includes at least one pin engaged with the arcuate slot and configured to move within the arcuate slot, enabling the yoke to pivot relative to the primary axis of the slider.

In some aspects, the internal hinge includes a spring coupled with the slider that provides an opening force against the at least one pin. In additional examples, the internal hinge includes a metal bracket with an opening (e.g., hole), where the extension member on the pivot engages the opening to form a detent and hold the pivot in a folded position for storage, for example, overcoming the spring bias.

In certain aspects, the bracket includes metal or a composite.

In particular cases, in an open position, the bracket is approximately entirely obstructed from view by a user.

In some implementations, the yoke includes a pivot member at a neck section thereof, the pivot member including a set of pivot pins.

In particular cases, the internal hinge includes a set of slots receiving the set of pivot pins and enabling rotation of the pivot member relative to the set of pivot pins.

In some aspects, the set of slots are located in a set of bumper members housed in the slider.

In certain cases, the headband further includes a set of pockets in the slider housing the bumper members. In various implementations, the bumper members are separate components coupled with the slider housing, and are formed of a compliant material.

In some aspects, each bumper member includes a set of limiters positioned to contact distinct portions of the pivot member.

In particular implementations, the set of limiters provide a damping feel or a tactile feel to a user when placed in contact with one of the portions of the pivot member.

In certain cases, the portions of the pivot member include a set of protrusions positioned to interfere with the set of limiters.

In some aspects, the internal hinge has a center of rotation (CoR) that is internal to a body of the slider.

In particular cases, the internal hinge has a center of rotation (CoR) that is external to a body of the slider.

In particular cases, the headband further includes an electro-acoustic transducer housed in the earphone for providing an audio output.

Two or more features described in this disclosure, including those described in this summary section, may be combined to form implementations not specifically described herein.

The details of one or more implementations are set forth in the accompanying drawings and the description below. Other features, objects and benefits will be apparent from the description and drawings, and from the claims.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a perspective view of an example headphone according to various implementations.

FIG. 2 is a side perspective of the headphone of FIG. 1 according to various implementations.

FIG. 3 is a perspective of a portion of a headband slider in a headphone according to various implementations.

FIG. 4 is a cross-sectional perspective of the slider of FIG. 3, according to various implementations.

FIG. 5 is a perspective view of a pivot member in a headband according to various implementations.

FIGS. 6 and 7 show perspective views of distinct sections of a headband slider according to various additional implementations.

FIG. 8 is a perspective end view of a section of a slider according to various implementations.

FIG. 9 is a partial sectional perspective view of a pivot mechanism in a slider according to various additional implementations.

FIGS. 10 and 11 show partial sectional views of a headband and pivot mechanism according to various implementations.

FIGS. 12-14 show distinct perspective views of portions of the pivot mechanism in FIGS. 10 and 11.

FIGS. 15-18 include partial sectional views of additional features of a headband slider according to various implementations.

FIG. 19 shows a portion of a headband for receiving a slider according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

Various disclosed implementations include headphone headbands that include an integral hinge. In particular examples, the hinge is located internal to the slider and enables the headphone yoke to pivot relative to the primary axis of the slider. These implementations may reduce manufacturing costs and/or complexity relative to conventional headphone headbands, and enhance visual appeal of headphones, among other benefits.

Commonly labeled components in the FIGURES are considered to be substantially equivalent components for the purposes of illustration, and redundant discussion of those components is omitted for clarity.

### Headphone

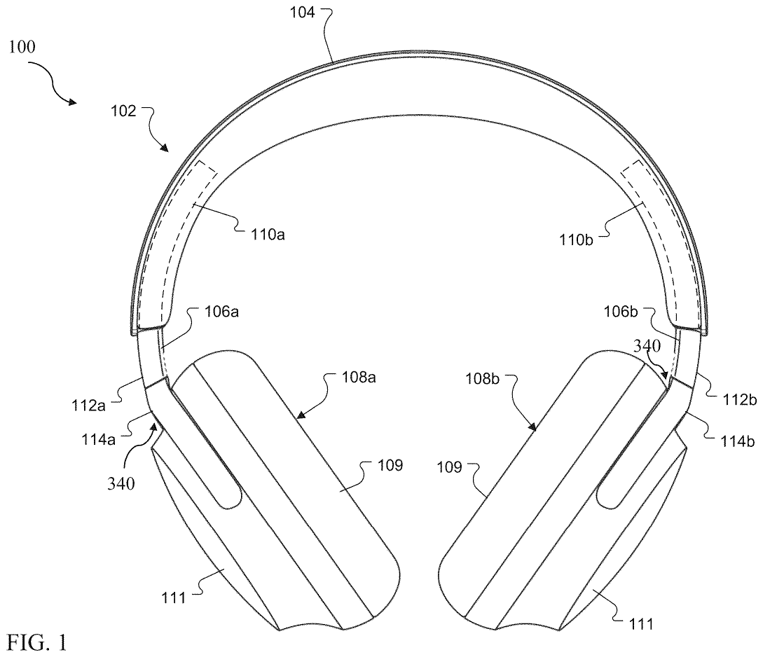

FIG. 1 shows headphones 100 according to various implementations. Headphones 100 include headband 102 which includes flat tubular cushion assembly 104 that is constructed and arranged to be placed over the crown of the head of a person. In some examples, tubular sliders 106a and 106b (collectively “106”) support earphones 108a and 108b (collectively “108”). The sliders engage with cushion assembly 104 in a manner which allows the sliders to be moved in and out of the cushion assembly to adjust the overall length of the headband so that they headphones can sit comfortably on, in or over the ears of the wearer. This overall arrangement of headphones is known in the art. Also, in some cases a microphone (not shown) can be included so that the headphones can be used as a headset. Further, some headphones or headsets include only one earphone, in which case there may be only one slider.

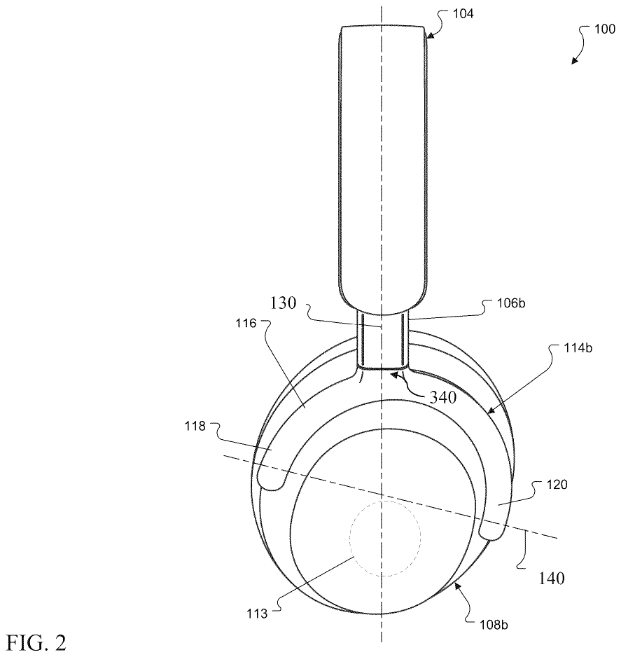

In certain cases, cushion assembly 104 is generally tubular. This arrangement allows the sliders to be received within the volume on the inside of the tube and also allows wiring to pass along the length of the cushion assembly. Alternative shapes of cushion assembly 104 are also possible. Sliders 106a and 106b are located in part in this interior volume of the cushion assembly. Each slider has a proximal end 110a, 110b located in the cushion assembly (e.g., end 110a of slider 106a) and a distal end 112a, 112b (e.g., end 112a of slider 106a). Coupling members 114a and 114b (collectively “114”) are pivotably coupled to sliders 106. The coupling members each carry an earphone 108 (a/k/a “earpiece”) at their far ends. Earphones 108a and 108b are shown in FIG. 1. Each of the earphones 108 includes an ear cushion 109 and an earcup 111 that supports an electro-acoustic transducer 113 (FIG. 2) .

In some non-limiting examples, the sliders each include generally hollow tubes with a generally flat exterior surface that lies closest to the head. The sliders may have an oblong cross-sectional shape, such as a stadium (aka “racetrack”), oval or elliptical shape. Various additional shapes are also possible according to implementations.

An example of a coupling member 114b is shown in more detail in FIG. 2. FIG. 2 shows a left coupling member 114b in headphones 100. A mirror-image of the design would be used for the right coupling member 114a. Coupling member 114b includes a yoke 116 with legs 118 and 120 that carry earphone 108. Earphone coupling members (not shown) are coupled to earphone 108b and allow it to rotate about axis 130. Also, coupling member 114b is engaged with slider 106b in a manner to allow the yoke to pivot about axis 140.

Additional features of the headphones 100, such as the conductive cable interconnecting earphones 108a and 108b are not illustrated but are known in the art, for example, as described in U.S. patent application Ser. No. 17/881,964 (Headphones, published as US PG Publication 2024/0048887), filed Aug. 5, 2022, the entire contents of which are hereby incorporated by reference.

### Headband

The following provides further description of an example headband for headphones, e.g., headphones 100. In some cases, the headband or portions thereof can be substituted for headband 102 in headphones 100 (FIGS. 1 and 2). Further, similarly labeled features in the drawings can be considered to be substantially similar components.

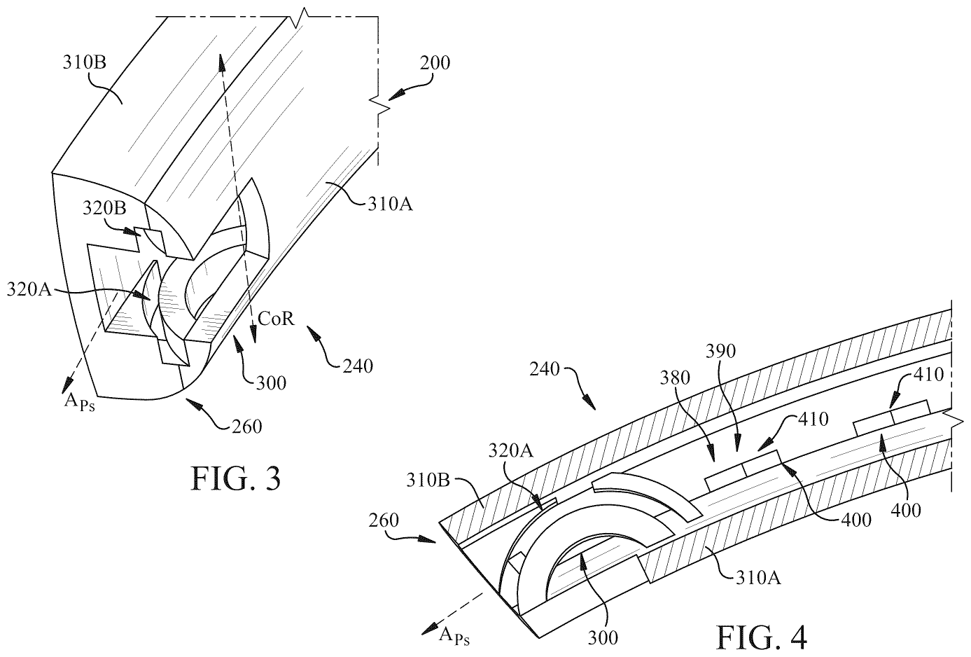

Turning to FIGS. 3-7, a headphone headband 200 is illustrated including a slider 240 for telescopically coupling to a cushion assembly, e.g., cushion assembly 104 in FIGS. 1 and 2. Additional aspects of distinct cushion assemblies are described and illustrated, for example, in U.S. patent application Ser. No. 18/940,945 (“Headphone Headband with Integral Slide Lock”, filed Nov. 8, 2024), the entire contents of which are hereby incorporated by reference.

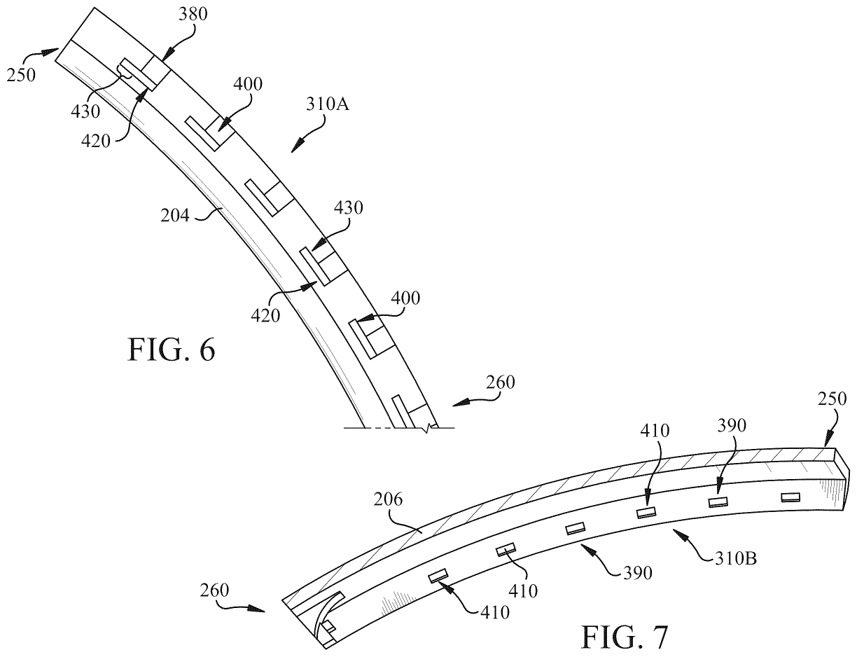

As illustrated in FIGS. 3-8, the slider 240 includes a proximal end 250 (FIGS. 6, 7) disposed within the cushion assembly 104, and a distal end 260 extending outward from the cushion assembly 104. It is understood that distal end 260 of slider 240 can be configured to couple with a yoke 116 in a headphone 100 such as illustrated in FIGS. 1 and 2, e.g., coupling the earphone 108 to the slider 240. It is understood that yoke 116 can generally couple with slider 240 in a similar manner as illustrated in FIGS. 1 and 2, with additional features described herein. Further features of yokes that are compatible with the disclosed implementations can be found in U.S. patent application Ser. No. 18/953,571 (“Headphone Headband with Integral Yoke Pivot”, filed Nov. 20, 2024), the entire contents of which are hereby incorporated by reference.

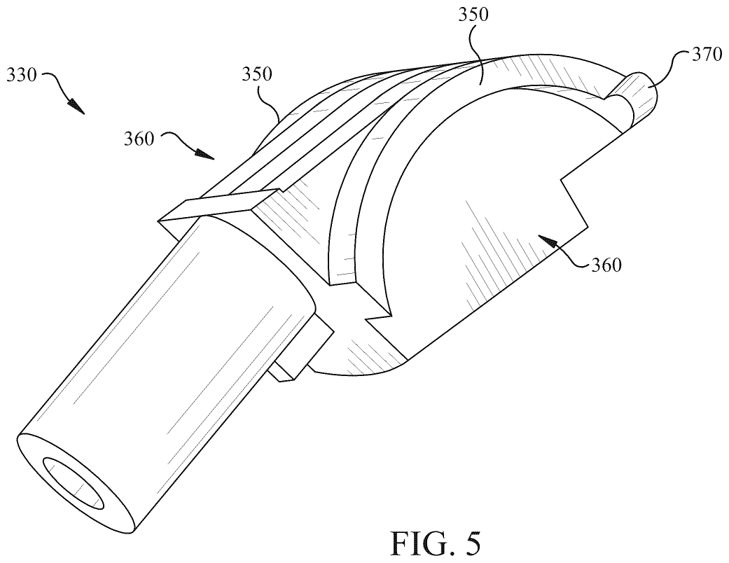

In particular implementations, e.g., as depicted in FIGS. 3-8, the slider 240 includes an internal hinge 300 enabling the yoke 116 to pivot relative to a primary axis (Aₚₛ) of the slider 240. In certain cases, the internal hinge 300 is contained within walls 310 of the slider 240. For example, in some cases, the slider 240 includes an inner wall section 310A and an outer wall section 310B that collectively form a hinge slot 320. In certain cases, the headphone headband 200 further includes a pivot member 330 (FIG. 5) extending from a neck portion 340 of the yoke 116 into the hinge slot 320. In some examples, the hinge slot 320 is an arcuate slot, e.g., a slot having an arcuate shape. In some such example implementations, the pivot member 330 has a set of arcuate protrusions 350 complementing the arcuate slot 320. Arcuate protrusions 350 can extend along a portion of the length of pivot member 330. In some examples, two hinge slots 320A, 320B are present, one on each side 360 of the pivot member 330. In certain examples where the hinge slots 320A and 320B are arcuate slots, the hinge slots 320 receive two arcuate protrusions 350. In certain implementations, the pivot member 330 includes a set of stops 370 that limit movement of the pivot member 330 relative to the hinge slot 320. These stops 370 can limit movement of the yoke 114 relative to the slider 240, for example, to control the extent to which the earcup 108 moves relative to the slider 240.

In certain implementations, as noted herein, the inner wall section 310A and an outer wall section 310B collectively define the hinge slot 320. In certain cases, the inner wall section 310A includes a first set of force-fit couplers 380 and the outer wall section 310B includes a second set of (complementary) force-fit couplers 390. In some examples, the force-fit couplers 380, 390 include mating slots 400 and complementary protrusions 410, such as snap-fit couplers, slide-to-fit couplers, etc. In certain aspects, the first set of force-fit couplers 380 and the second set of force-fit couplers 390 enables fastener-free connection between the inner wall section 310A and the outer wall section 310B.

In some example implementations, as noted herein, the first set of force-fit couplers 380 includes a set of (e.g., two or more) slots 400 and the second set of force-fit couplers 390 includes a set of (e.g., two or more) protrusions 410. The slots 400 can include a loading portion 420 and a locking portion 430, e.g., as illustrated in FIG. 6. For example, the loading portion 420 can enable a protrusion 410 to move in and out of the slot 400 (such as in a direction perpendicular to Aₚₛ), while the locking portion 430 limits movement of the protrusion 410. In some examples, slots 400 are oversized relative to protrusions 410 in at least one dimension, enabling loading, unloading, and locking.

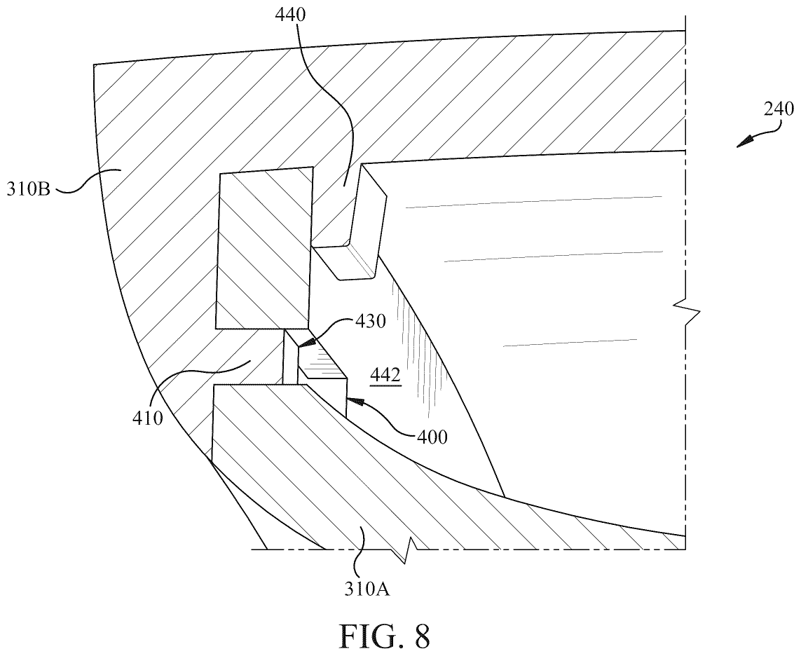

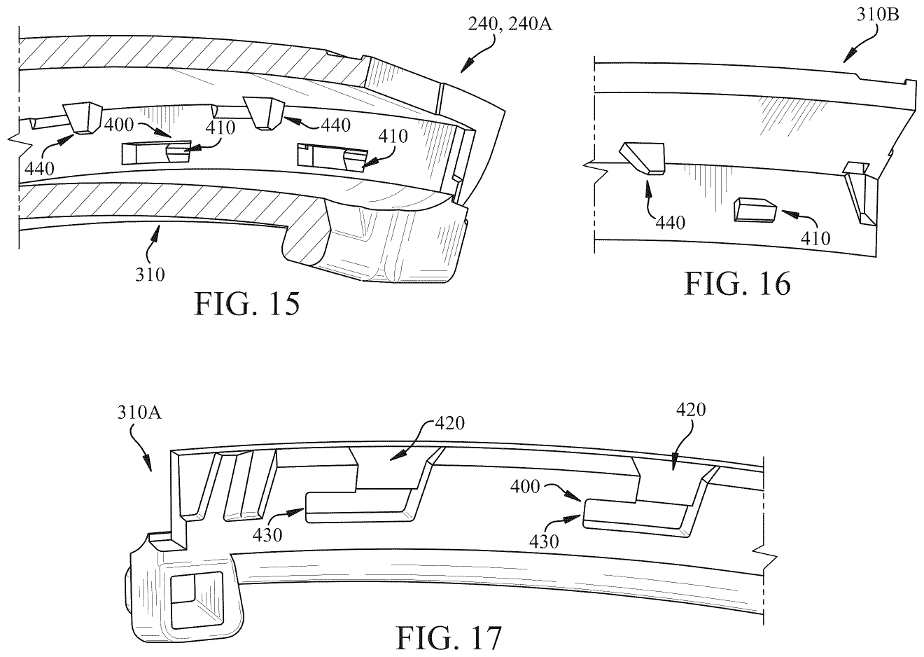

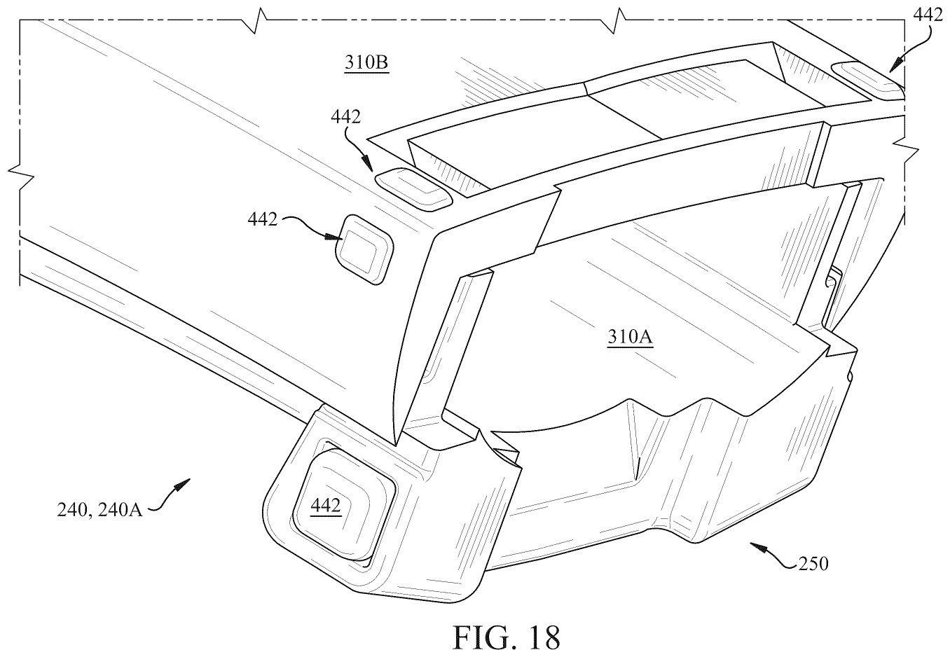

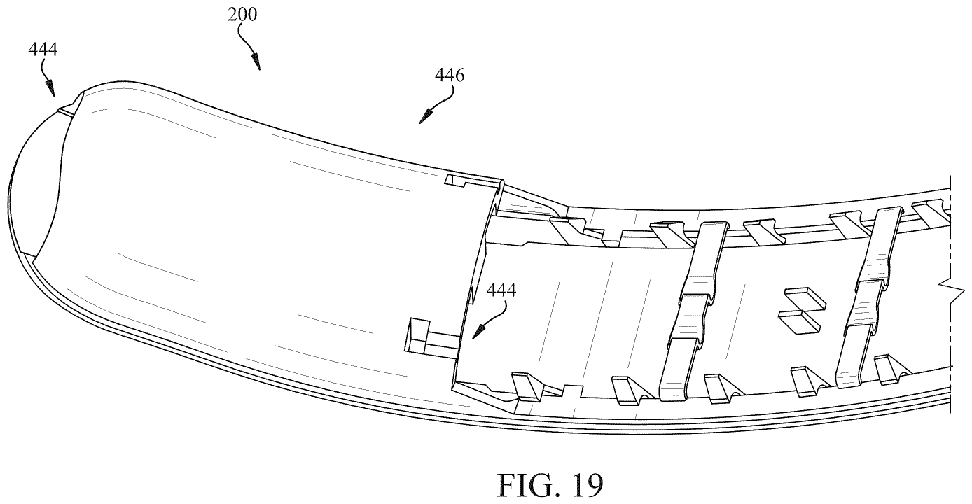

In additional particular implementations, as shown in FIG. 8, the inner wall section 310A and/or the outer wall section 310B includes a set of stabilizing protrusions 440 that inhibit deflection of the inner wall section 310A relative to the outer wall section 310B. In particular examples, the stabilizing protrusions 440 are positioned to interfere with the inner wall section 310A (e.g., at an inner surface 442 thereof) to retain the inner wall section 310A adjacent the outer all section 310B. Additional features of example slots 400, protrusions 410, and stabilizing protrusions 440 are illustrated in FIGS. 15-18. FIG. 18 also shows bumpers 442 (e.g., compliant material bumpers) in one or more locations on the inner wall section 310A and/or the outer wall section 310B that may aid in providing friction feel when moving the slider 240 within a headband channel, e.g., a channel 444 of a headband 446 depicted in FIG. 19. Additional details of headbands compatible with the sliders herein (e.g., sliders 240, 240A) are described in U.S. patent application Ser. No. 18/940,945 (“Headphone Headband with Integral Slide Lock”, filed Nov. 8, 2024), previously incorporated by reference herein.

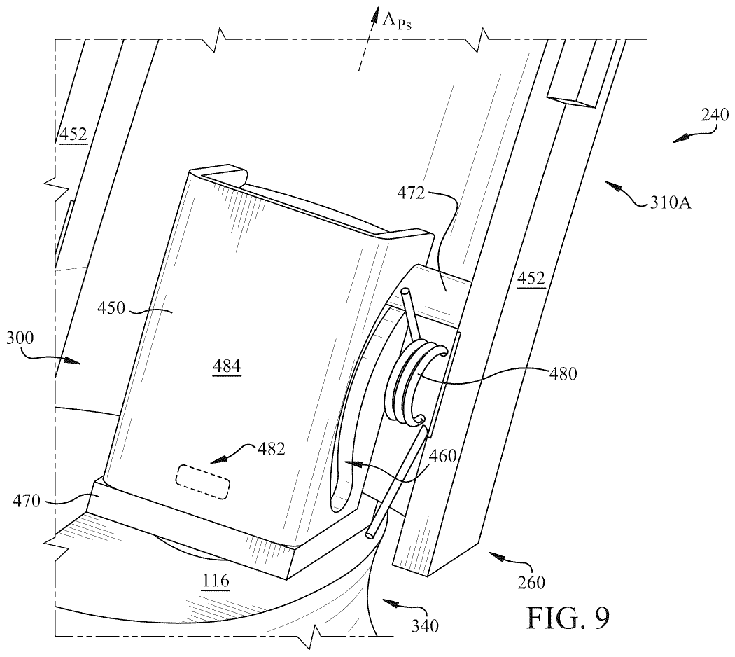

In some additional or alternative aspects, as depicted in FIG. 9, the internal hinge 300 includes a bracket 450 pivotably coupled with the yoke 116 and housed within walls 452 of the slider 240. The bracket 450 can be fixed to the wall(s) 452 of the slider, e.g., the inner wall portion 310A. In various implementations, the bracket 450 includes an arcuate slot 460 that extends through at least a portion thereof. In various implementations, the slider 240 includes a pivot member 470 coupled with the yoke 116, e.g., at neck portion 340. The pivot member 470 can include at least one pin 472 engaged with the arcuate slot 460 and configured to move within the arcuate slot 460. In some cases, the pivot member 470 includes a compliant material at a contact surface of the bracket 450. The interaction between the pin 472 and the arcuate slot 460 can enable the yoke 116 to pivot relative to the primary axis Aₚₛ of the slider 240. In some aspects, the internal hinge 300 includes a spring 480 coupled with the slider 240 that provides an opening force against the pin(s) 472. In some cases, multiple springs (e.g., two springs) 480 are used to provide opening force against corresponding pins 472 on each side of the bracket 450. In additional examples, illustrated in phantom, the bracket 450 includes an additional opening 482 (e.g., through outer surface 484), and the pivot member 470 includes an extension member (not shown) that engages the opening 482 to form a detent and hold the pivot member 470 in a folded position for storage, for example, overcoming the spring bias of spring 480. In some cases, the extension member is located on pin 472, and is configured to mate with opening 482 to form the detent. In certain aspects, the bracket 450 includes metal or a composite. In a particular example, the bracket includes metal. In various implementations, in an open position, the bracket 450 is approximately entirely obstructed from view by a user.

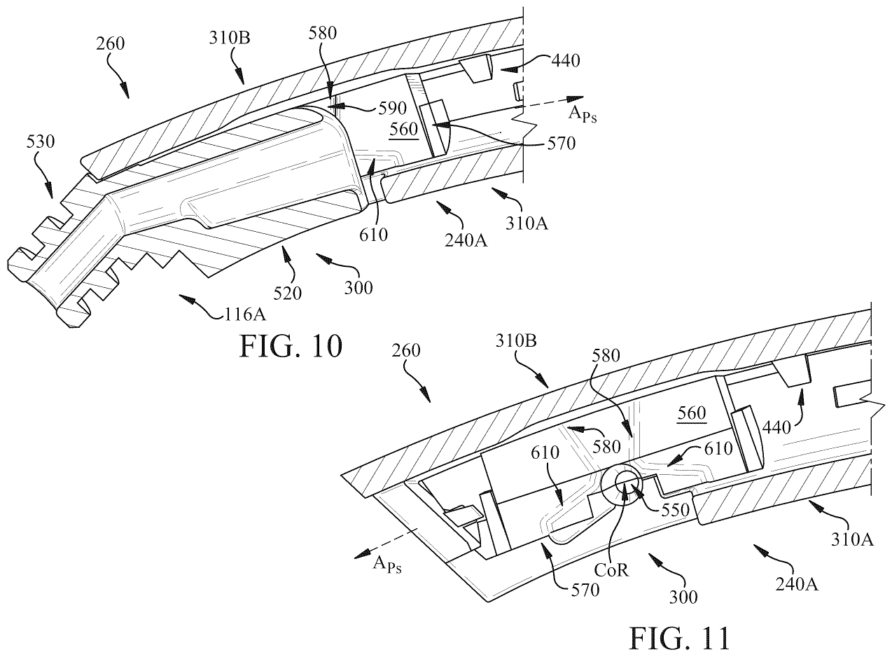

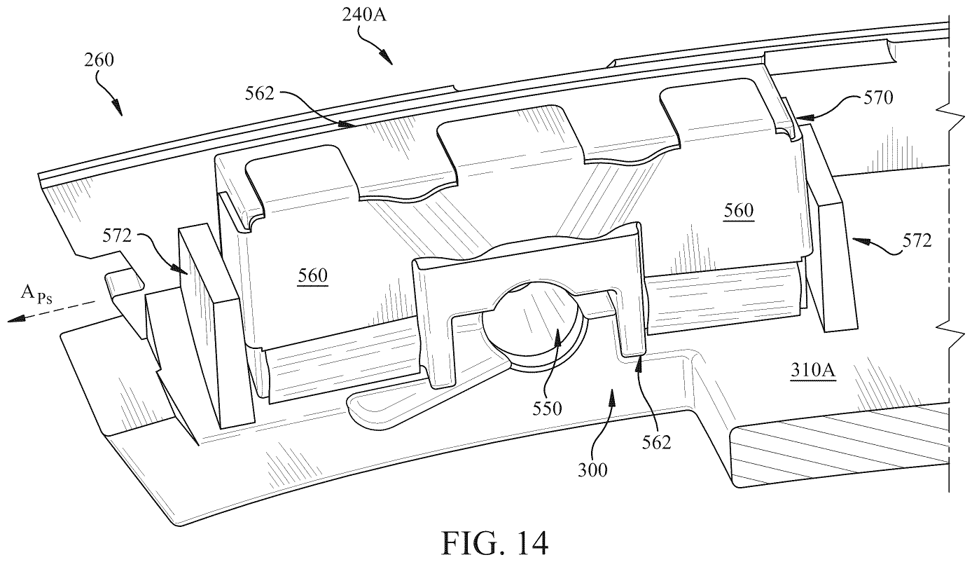

In still further implementations, as shown in FIGS. 10-14, another implementation of a yoke 116A can be configured to interact with a slider 240A, e.g., to provide an internal pivot mechanism. As shown in FIGS. 10-14, yoke 116A includes a pivot member 520 at a neck section 530 thereof. The pivot member 520 can include a set of pivot pins 540, with one shown in FIG. 13. In these example implementations, the internal hinge 300 includes a set of slots 550 receiving the set of pivot pins 540 and enabling rotation of the pivot member 520 relative to the set of pivot pins 540. In some of these cases, the set of slots 550 are located in a set of bumper members 560 housed in the slider 240A. In certain cases, bumper members 560 with slots 550 are located on both sides of the pivot member 520. Bumper members 560 can be housed in pockets 570 in the slider 240A. Pockets 570 can be defined by one or more walls 572 inside the slider 240A, e.g., in inner wall section 310A as illustrated in FIG. 14. In some non-limiting examples, bumper members 560 are enclosed in a casing 562 such as a metal (e.g., sheet metal), as shown in FIG. 14. However, the casing 562 is optional in various implementations. In some cases, the bumper members 560 form a portion of the slot 550, and a portion of the inner wall section 310A forms an additional portion of the slot 550. In such cases, the bumper members 560 fit in the inner wall section 310A and outer wall section 310B in a complementary manner to define the slot(s) 550. Bumper members 560 can be coupled with the slider 240A housing, e.g., via force fit/interference fit, flex fit, or male/female connectors. In some cases, the bumper members 560 are formed of a compliant material such as silicone or a composite. The bumper members 560 can be separately formed components from slider 240A (e.g., separately from the wall sections 310). In some aspects, each bumper member 560 includes a set of limiters 580 (e.g., FIGS. 11-13) positioned to contact distinct portions 590 of the pivot member 520. The set of limiters 580 can be configured to provide a damping feel or a tactile feel to a user when placed in contact with one of the portions 590 of the pivot member 520. In certain cases, the portions 590 of the pivot member 520 include a set of protrusions 600 positioned to interfere with the set of limiters 580. Additional limiters 610 can also be used to provide a damping feel during rotation of the yoke 116A relative to the slider 240A, e.g., when surfaces of the pivot member 520 contact the additional limiters 610.

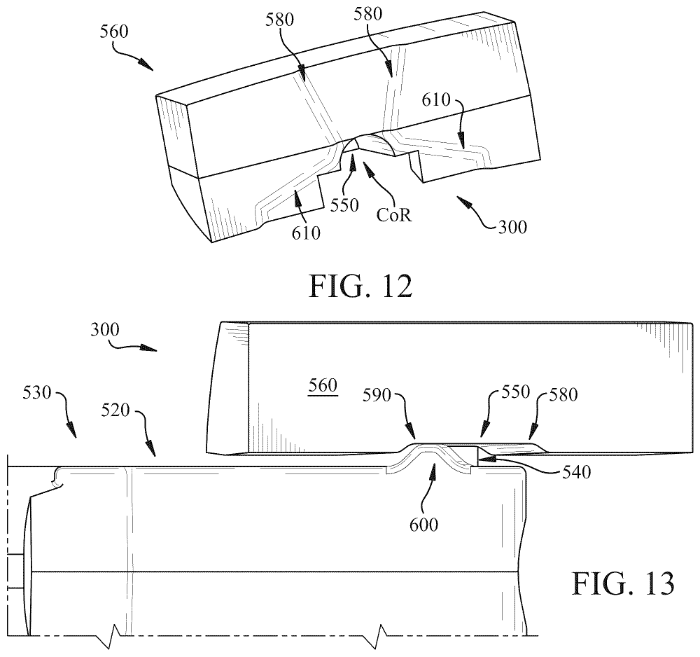

As described herein, the various disclosed internal hinge mechanisms can be integrated in, or internal to, sliders 240. In some cases, e.g., as shown in FIGS. 9-14, the internal hinge 300 has a center of rotation (CoR) that is internal to the body of the slider 240, e.g., internal to wall sections 310. CoR is illustrated in FIGS. 11 and 12 as the center of slot(s) 550. In other cases, such as illustrated in implementations in FIGS. 3-5, the internal hinge 300 has a center of rotation (CoR) that is external to the body of the slider 240, e.g., external to wall sections 310. CoR is illustrated in FIG. 3 as an axis for clarity. In all implementations, the hinge mechanism can be contained within, or substantially contained within, the sliders 240, 240A, to provide various benefits described herein.

For example, as noted herein, the headbands disclosed according to various implementations can reduce manufacturing costs and/or complexity relative to conventional headphone headbands. In particular cases, the headbands can minimize (or eliminate) the need for separate fasteners to maintain a hinge between a headband slider and a yoke. The internal hinge can also enhance the useful life of the headband by reducing failures in moving components. Additionally, relative to certain conventional headbands, the headbands disclosed according to various implementations can be visually appealing as having fewer visible hinge components (or altogether eliminating such visible components). Even further, the headbands disclosed according to various implementations can be beneficially lighter, and in some cases, smaller than conventional headbands due in part to reduction in fasteners and other components. Manufacturing headbands disclosed according to various implementations can also be simpler than manufacturing conventional headbands, for example, with fewer operation steps, less time, and/or fewer tools required.

The systems and methods disclosed herein may include or operate in, in some examples, headsets, headphones, hearing aids, or other personal audio devices, as well as acoustic noise reduction systems that may be applied to home, office, or automotive environments. Throughout this disclosure the terms “headset,” “headphone,” “earphone,” and “headphone set” are used interchangeably, and no distinction is meant to be made by the use of one term over another unless the context clearly indicates otherwise. Additionally, aspects and examples in accord with those disclosed herein are applicable to various form factors, such as in-ear transducers or earbuds and on-ear or over-ear headphones, and others.

Examples disclosed may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

For various components described herein, a designation of “a” or “b” in the reference numeral may be used to indicate “right” or “left” versions of one or more components. When no such designation is included, the description is without regard to the right or left and is equally applicable to either of the right or left, which is generally the case for the various examples described herein. Additionally, aspects and examples described herein are equally applicable to monaural or single-sided personal acoustic devices and do not necessarily require both of a right and left side.

Examples of the headphones described herein are not limited in application to the details of construction and the arrangement of components set forth in the following description or illustrated in the accompanying drawings. The headphones are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

The term “approximately” as used with respect to values herein can allot for a nominal variation from absolute values, e.g., of several percent or less.

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. The terms “apparatus” and “device” are also used generically and interchangeably unless otherwise indicated by the particular context. The terms “element” and “module” are typically used to indicate a portion of a greater configuration. Any incorporation by reference of a portion of a document shall also be understood to incorporate definitions of terms or variables that are referenced within the portion, where such definitions appear elsewhere in the document, as well as any figures referenced in the incorporated portion.

Other embodiments not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

We claim:

1. A headphone headband, comprising:
a cushion assembly;
a slider telescopically coupled to the cushion assembly, the slider comprising a proximal end disposed within the cushion assembly and a distal end extending outward from the cushion assembly;
an earphone; and
a yoke coupling the earphone to the distal end of the slider,
wherein the slider includes an internal hinge enabling the yoke to pivot relative to a primary axis of the slider.

2. The headphone headband of claim 1, wherein the internal hinge is contained within walls of the slider.

3. The headphone headband of claim 1, wherein the slider includes an inner wall and an outer wall that collectively form an arcuate slot.

4. The headphone headband of claim 3, further comprising a pivot member extending from a neck portion of the yoke into the arcuate slot, the pivot member having a set of arcuate protrusions complementing the arcuate slot.

5. The headphone headband of claim 4, wherein the pivot member further comprises a set of stops that limit movement of the pivot member relative to the arcuate slot.

6. The headphone headband of claim 1, wherein the slider comprises an inner wall section and an outer wall section that collectively define a hinge slot.

7. The headphone headband of claim 6, wherein the inner wall section includes a first set of force-fit couplers and the outer wall section includes a second set of complementary force-fit couplers.

8. The headphone headband of claim 7, wherein the first set of force-fit couplers and the second set of force-fit couplers enables fastener-free connection between the inner wall section and the outer wall section.

9. The headphone headband of claim 7, wherein the first set of force-fit couplers includes a set of slots and wherein the second set of force-fit couplers includes a set of protrusions, wherein each of the slots includes a loading portion and a locking portion, and
wherein at least one of the inner wall section or the outer wall section includes a set of stabilizing protrusions that inhibit deflection of the inner wall section relative to the outer wall section.

10. The headphone headband of claim 1, wherein the internal hinge includes a bracket coupled with the yoke and housed within walls of the slider.

11. The headphone headband of claim 10, wherein the bracket includes an arcuate slot and wherein the slider includes at least one pin engaged with the arcuate slot and configured to move within the arcuate slot, enabling the yoke to pivot relative to the primary axis of the slider, wherein the internal hinge includes a spring coupled with the slider that provides an opening force against the at least one pin.

12. The headphone headband of claim 10, wherein the bracket includes metal or a composite.

13. The headphone headband of claim 10, wherein in an open position, the bracket is approximately entirely obstructed from view by a user.

14. The headphone headband of claim 1, wherein the yoke includes a pivot member at a neck section thereof, the pivot member including a set of pivot pins.

15. The headphone headband of claim 14, wherein the internal hinge includes a set of slots receiving the set of pivot pins and enabling rotation of the pivot member relative to the set of pivot pins.

16. The headphone headband of claim 15, wherein the set of slots are located in a set of bumper members housed in the slider.

17. The headphone headband of claim 16, further comprising a set of pockets in the slider housing the bumper members.

18. The headphone headband of claim 17, wherein each bumper member includes a set of limiters positioned to contact distinct portions of the pivot member.

19. The headphone headband of claim 18, wherein either:
i) the set of limiters provide a damping feel or a tactile feel to a user when placed in contact with one of the portions of the pivot member, or
ii) the portions of the pivot member include a set of protrusions positioned to interfere with the set of limiters.

20. The headphone headband of claim 1, wherein the internal hinge has a center of rotation (CoR) that is internal to a body of the slider, or external to a body of the slider.
